(19) United States
(12) Patent Application Publication
(10) Pub. No.: US 2012/0062341 A1
(43) Pub. Date: Mar. 15, 2012

(54) MICRO BAND-PASS FILTER

(75) Inventors: WEI-SHIANG HUANG, CHANGHUA COUNTY (TW); WEI-HAO YEH, TAICHUNG CITY (TW)

(73) Assignees: UNIVERSAL GLOBAL SCIENTIFIC INDUSTRIAL CO., LTD., NANTOU COUNTY (TW); UNIVERSAL SCIENTIFIC INDUSTRIAL (SHANGHAI) CO., LTD., SHANGHAI (CN)

(21) Appl. No.: 13/053,459

(22) Filed: Mar. 22, 2011

(30) Foreign Application Priority Data
Sep. 10, 2010 (TW) 99130746

(51) Int. Cl. H01P 1/205

(52) U.S. Cl. 333/203

(57) ABSTRACT

A micro band-pass filter is disclosed. The micro band-pass filter includes a first resonator having a first inter-digital unit and a second inter-digital unit, which is connected to a first wavelength-impedance converter, on two ends thereof, and a second resonator having a third inter-digital unit and a fourth inter-digital, which is connected to a second wavelength-impedance converter unit on two ends thereof. The second inter-digital unit is adapted to face the third inter-digital unit when forming a first inter-digital coupling structure along with the third inter-digital unit, and the first inter-digital unit is adapted to face the fourth inter-digital unit when forming a second inter-digital coupling structure.

### BACKGROUND OF THE INVENTION

1. Field of the Invention

The invention relates to a micro band-pass filter, and more particularly, to a dual frequency band-pass filter.

2. Description of Related Art

When a microwave filter is implemented in terms of a micro strip line, the characteristic of a sinusoidal voltage of an electromagnetic wave may reflect on the micro strip line. Therefore, a frequency response of the electromagnetic wave on the micro strip line would be in form of periodical pass bands, which is characterized as a frequency doubling effect of the microwave filter. As the result, a low-pass microwave filter in a serial connection to the band-pass microwave filter is necessary so as to eliminate the frequency doubling effect.

The utilization of the low-pass microwave filter may cause a complicated micro strip line structure and occupy a considerable area. Since a single band-pass filter generally could not meet the increasing demand, a dual band-pass filter utilizing the low-pass microwave filter could only further complicate the entire structure of the micro strip line and occupy a larger area.

When an electromagnetic interference (EMI) test is performed on the dual band-pass filter, harmonic wave of second-order, third-order and fourth-order generally fail to comply with corresponding standards. Thus, it is desirable to develop a dual band-pass filter having simplified structural design, occupying a less area, and in compliance with prevailing standards.

### SUMMARY OF THE INVENTION

A micro band-pass filter is disclosed. The micro band-pass filter includes a wavelength-impedance converter connected to a resonator and a position of a transmission zero may be established based on the wavelength-impedance converter to reduce the frequency doubling effect. The resonator has inter-digital capacitors on two ends to increase a coupling amount between the resonators. The length of the resonator of the micro band-pass filter of the invention may be shortened with substantially the same frequency response so that the area occupied by the micro band-pass filter may be further reduced.

An embodiment of a micro band-pass filter of the invention comprises a first resonator having a first inter-digital unit and a second inter-digital unit, which is connected to a first wavelength-impedance converter, on two ends thereof, and a second resonator having a third inter-digital unit and a fourth inter-digital unit, which is connected to a second wavelength-impedance converter unit on two ends thereof. The second inter-digital unit may face the third inter-digital unit when forming a first inter-digital coupling structure along with the third inter-digital unit. Meanwhile, the first inter-digital unit may face the fourth inter-digital unit when forming a second inter-digital coupling structure along with the fourth inter-digital unit.

According to another embodiment of a micro band-pass filter of the invention, the first resonator further has a third wavelength-impedance converter disposed between the first inter-digital unit and the second digital unit, and the second resonator further has a fourth wavelength-impedance converter disposed between the third inter-digital unit and the fourth digital unit.

According to another embodiment of a micro band-pass filter of the invention, which further comprises a plurality of coupled resonators capable of providing a second transmission zero.

The frequency doubling problem associated with the conventional pass-band filter may be solved by the micro band-pass filter proposed by the present invention without serially connecting a low pass microwave filter to the micro band-pass filter.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of a micro band-pass filter in accordance with one embodiment of the present invention;

FIG. 2 is a schematic diagram of a frequency response of the embodiment shown in FIG. 1;

FIG. 3 is a schematic diagram showing a curve of a coupling coefficient of the embodiment of FIG. 1;

FIG. 4 is a schematic diagram of micro band-pass filter according to the second embodiment of the present invention;

FIG. 5 is a schematic diagram of micro band-pass filter according to the third embodiment of the present invention;

FIG. 6 is a schematic diagram of micro band-pass filter according to the fourth embodiment of the present invention;

FIG. 7 is a diagram showing frequency response of the fourth embodiment of the invention; and

FIG. 8 is a diagram showing another frequency response of the fourth embodiment of the invention.

### DETAILED DESCRIPTION OF THE PREFERRED EMBODIMENTS

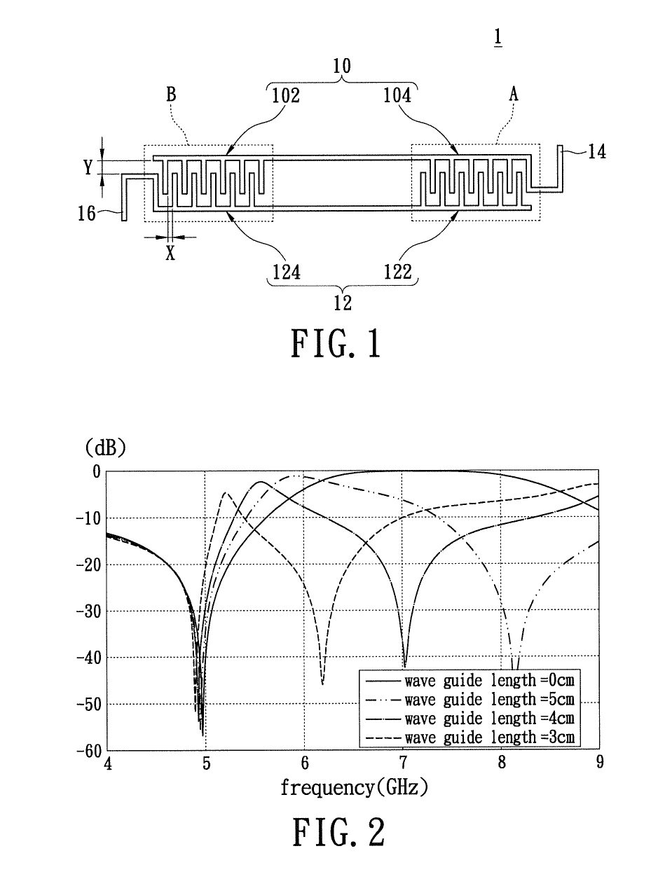

Referring to FIG. 1 in which a schematic diagram of a micro band-pass filter 1 in accordance with one embodiment of the present invention is illustrated. The band-pass filter 1 comprises a first resonator 10 and a second resonator 12. A first inter-digital unit 102 and a second inter-digital unit 104 are disposed on two ends of the first resonator 10. The second inter-digital unit 104 is connected to a first wavelength-impedance converter 14. In addition, a third inter-digital unit 122 and a fourth inter-digital unit 124 are disposed on two ends of the second resonator 12. The fourth inter-digital unit 124 is further connected to a second wavelength-impedance converter 16.

In one implementation, the first, the second, the third and the fourth inter-digital units 102, 104, 122 and 124 are inter-digital capacitors. The inter-digital capacitor may be in form of comb structure having multiple combs between which slots are formed. The third inter-digital unit 122 may have the combs thereof facing the slots of the second inter-digital unit 104. In other words, the combs of the second inter-digital unit 104 may face the slots of the third inter-digital unit 122. The spatial relationship between the third inter-digital unit 122 and the second inter-digital unit 104 may be the same as that between the first inter-digital unit 102 and the fourth inter-digital unit 124. The third inter-digital unit 122 and the second inter-digital unit 104 form a first inter-digital coupling structure A. The fourth inter-digital unit 124 and the first inter-digital unit 102 form a second inter-digital coupling structure B. The comb of the first inter-digital unit 102 may be spaced from the comb of the fourth inter-digital unit 124 by a gap of X, which may also be the distance between the combs of the second inter-digital unit 104 and the third inter-digital unit 122. Another gap of Y is between the third inter-digital unit 122 and the second inter-digital unit 104, and between the fourth inter-digital unit 124 and the first inter-digital unit 102.

Compared with a band-pass filter having a conventional stepped resonator, the micro band-pass filter 1 adopting the inter-digital capacitors on two ends thereof may shorten the length (about ¼ wavelength) and downsize the width (about 25 percents) of the resonator. For the same frequency response, the micro band-pass filter 1 occupies a smaller area. Since the inter-digital capacitors of the first resonator 10 and the second resonator 12 are disposed to ensure an electromagnetic coupling to significantly reduce an insertion loss of the micro band-pass filter and to further minimize the loss of a radio frequency power.

Referring to FIG. 2 in which a schematic diagram of a frequency response of the embodiment shown in FIG. 1 is illustrated. In one implementation, the first wavelength-impedance converter 14 and the second wavelength-impedance converter 16 are open stubs of an identical length. A first transmission zero is established by the first wavelength-impedance converter 14 and the second wavelength-impedance converter 16 to increase an attenuation rate and shield noise effectively outside of the pass band. The first wavelength-impedance converter 14 and the second wavelength-impedance converter 16 may be curved micro strip lines and inversely symmetrically disposed on the micro band-pass filter 1 to reduce the associated occupied area.

As shown in FIG. 2, different first transmission zeros may be established by changing wave guide lengths of the first wavelength-impedance converter 14 and the second wavelength-impedance converter 16. An attenuation characteristic associated with the pass-band of the micro band-pass filter 1 may be regulated by adjusting the wave guide length of the first wavelength-impedance converter 14 and the second quarter-wavelength impedance converter 16.

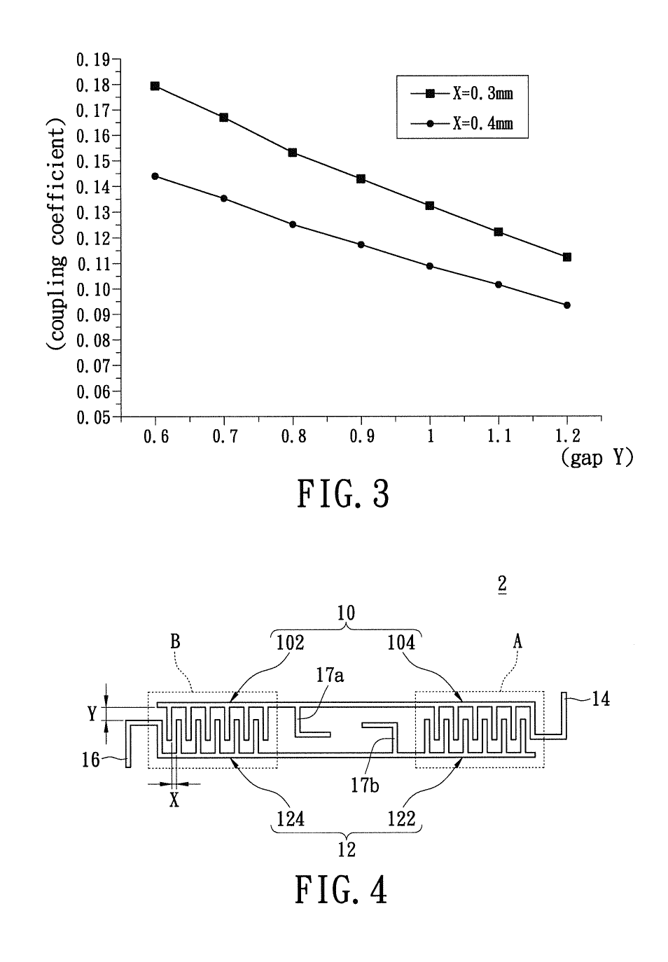

Referring to FIG. 3 in which a schematic diagram showing a curve of a coupling efficient of the embodiment illustrated in FIG. 1. In the first inter-digital coupling structure A, the gap of X dictates the coupling coefficient. More specifically, when the gap of Y remains unchanged the gap of X is inversely proportional to the coupling coefficient. Similarly, in the second inter-digital coupling structure B, when the gap of Y remains unchanged, the gap of X is inversely proportional to the coupling coefficient.

In addition, in the micro band-pass filter 1 the frequency response of the first resonator 10 may be associated with a first pass band frequency and a second pass band frequency while the frequency response of the second resonator 12 may be associated with a third pass band frequency and a fourth pass band frequency. The first pass band frequency and the second pass band frequency may be determined by the size of the first inter-digital unit 102 and the size of the second inter-digital unit 104. Similarly, the third pass band frequency and the fourth pass band frequency may also be determined by the size of the third inter-digital unit 122 and the size of the fourth inter-digital unit 124. In this embodiment, the first pass band frequency generated from first resonator 10 may overlap (or be in congruence with) the third pass band frequency generated from second resonator 12, and the second pass band frequency generated from first resonator 10 may be configured to overlap (or be incongruence with) the fourth pass band frequency generated from second resonator 12.

In conjunction with FIG. 1, FIG. 4 shows a schematic diagram of micro band-pass filter 2 according to the second embodiment of the present invention. The micro band-pass filter 2 further comprises a third wavelength-impedance converter 17a and a fourth wavelength-impedance converter 17b. The third wavelength-impedance converter 17a is disposed between the first inter-digital unit 102 and the second inter-digital unit 104 and connects to the first inter-digital unit 102 and the second inter-digital unit 104. The fourth wavelength-impedance converter 17b is disposed between the third inter-digital unit 122 and the fourth inter-digital unit 124 and connects to the third inter-digital unit 122 and the fourth inter-digital units 124. The third wavelength-impedance converter 17a and the fourth wavelength-impedance converter 17b may be of the same predetermined length, which may be different to the length of the first wavelength-impedance converter 14 and the second wavelength-impedance converter 16.

The third wavelength-impedance converter 17a and the fourth wavelength-impedance converter 17b may be implemented in terms of open stubs. In addition to the first transmission zero established by the first wavelength-impedance converter 14 and the second wavelength-impedance converter 16, a second transmission zero may be further established by the third wavelength-impedance converter 17a and the fourth wavelength-impedance converter 17b to increase an attenuation rate outside of the pass band and to shield noises outside of the pass band. The attenuation characteristics of the pass band of the micro band-pass filter 2 may be established by adjusting the wave guide length of the third wavelength-impedance converter 17a and the fourth wavelength-impedance converter 17b.

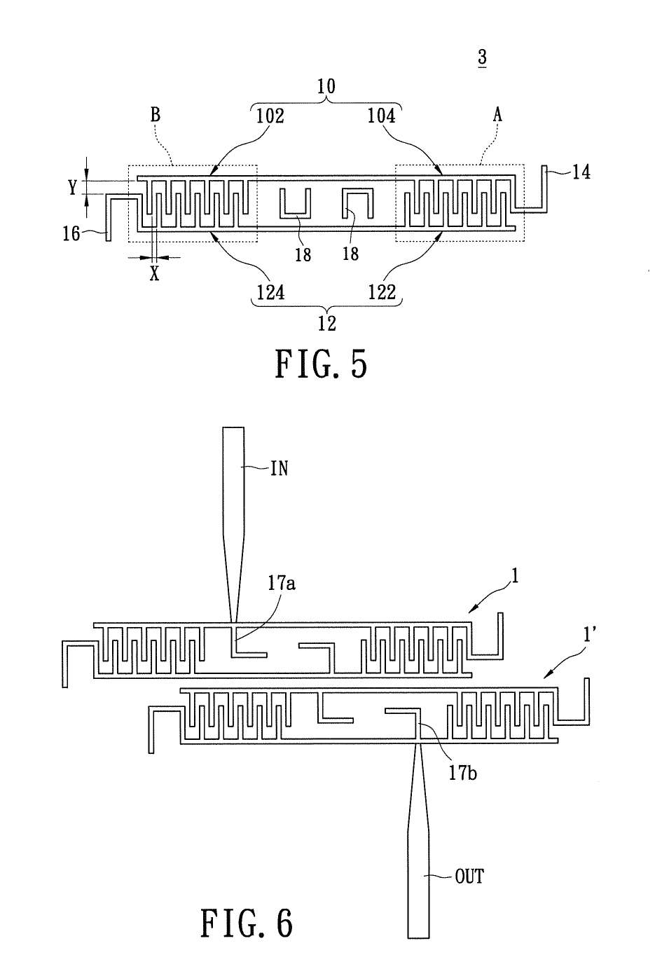

In conjunction with FIG. 1, FIG. 5 shows a schematic diagram of micro band-pass filter 3 according to the third embodiment of the present invention. The micro band-pass filter 3 further comprises at least two coupled resonators 18. The coupled resonators 18 are disposed between the first inter-digital coupling structure A and the second inter-digital coupling structure B to establish the second transmission zero so as to increase the attenuation rate and shield the noise outside of the pass band. The attenuation characteristics of the pass-band of the micro band-pass filter 3 may be changed by adjusting sizes of the coupled resonators 18.

In conjunction with FIG. 4, FIG. 6 is a schematic diagram of micro band-pass filter according to the fourth embodiment and is the best embodiment, which shows a micro band-pass filter apparatus comprising a micro band-pass filter 1 and a micro band-pass filter 1′. The micro band-pass filter 1 and the micro band-pass filter 1′ may be coupled in a parallel fashion to reduce high order harmonic waves and increase the resolution of the band-pass frequency.

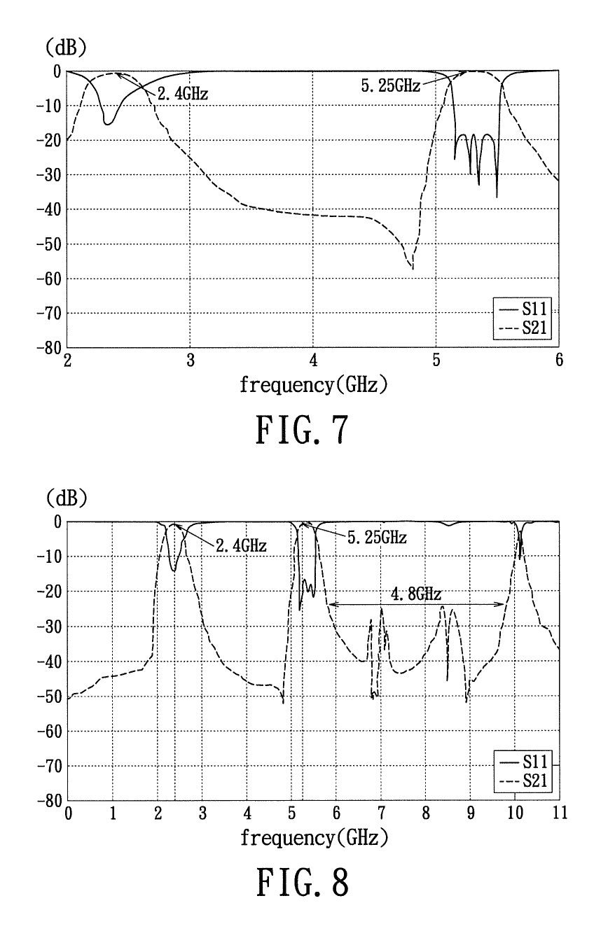

A radio frequency input port IN is connected to the third wavelength-impedance converter 17a and a radio frequency output port OUT is connected to the fourth wavelength-impedance converter 17b. A corresponding frequency response shown in FIG. 7 may show that the first pass band frequency is at about 2.4 GHz, and the second pass band frequency is at about 5.25 GHz. Accordingly, the band-pass filter apparatus comprising the micro band-pass filter 1 and the micro band-pass filter 1′ may be associated with a dual pass bands.

In conjunction with FIG. 6, FIG. 8 is a schematic diagram of another frequency response of the filter apparatus shown in FIG. 7. More specifically, only two frequency pass bands (2.4 GHz and 5.25 GHz) can be established in a frequency range of 0˜10 GHz, increasing an available bandwidth absent other pass bands.

The micro band-pass filter of the invention has the following advantages: (1) no lump element is needed, so that the entire manufacturing cost may be reduced, (2) the transmission zero may be established by manipulating the wavelength-impedance converter to reduce the frequency doubling effect with only two pass-bands (2.4 GHz and 5.25 GHz) in the frequency range 0˜10 GHz (for example), and (3) the incorporation of the inter-digital units on two ends of the resonator may increase the coupling amount, shortening the length of the resonator of the micro band-pass filter with substantially the same frequency response so as to reduce the area occupied by the micro band-pass filter.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A micro band-pass filter, comprising:
a first resonator having a first inter-digital unit and a second inter-digital unit, which is connected to a first wavelength-impedance converter, on two ends thereof; and
a second resonator having a third inter-digital unit and a fourth inter-digital, which is connected to a second wavelength-impedance converter unit, on two ends thereof, wherein the second inter-digital unit faces the third inter-digital unit when forming a first inter-digital coupling structure along with the third inter-digital unit, and the first inter-digital unit faces the fourth inter-digital unit when forming a second inter-digital coupling structure along with the fourth inter-digital unit.

2. The micro band-pass filter as claimed in claim 1, wherein a first band-pass frequency and a second band-pass frequency depend on sizes of the first inter-digital unit and the second inter-digital unit.

3. The micro band-pass filter as claimed in claim 1, wherein a third band-pass frequency and a fourth band-pass frequency depend on sizes of the third inter-digital unit and the fourth inter-digital unit.

4. The micro band-pass filter as claimed in claim 1, wherein a gap in the first inter-digital coupling structure and a gap in the second inter-digital coupling structure determine a coupling amount.

5. The micro band-pass filter as claimed in claim 1, wherein the first wavelength-impedance converter and second wavelength-impedance converters provide a first transmission zero.

6. The micro band-pass filter as claimed in claim 5, wherein the first wavelength-impedance converter and the second wavelength-impedance converter are curved micro strips and inversely symmetrically disposed.

7. The micro band-pass filter as claimed in claim 1, wherein the first resonator further has a third wavelength-impedance converter disposed between the first inter-digital unit and the second digital unit, and the second resonator further has a fourth wavelength-impedance converter disposed between the third inter-digital unit and the fourth digital unit.

8. The micro band-pass filter as claimed in claim 7, wherein the third wavelength-impedance converter and the fourth wavelength-impedance converters provide a second transmission zero.

9. The micro band-pass filter as claimed in claim 8, wherein the third wavelength-impedance converter and the fourth wavelength-impedance converter are curved micro strips and inversely symmetrically disposed.

10. The micro band-pass filter as claimed in claim 1 further comprising at least two coupled resonators disposed between the first inter-digital coupling structure and the second inter-digital coupling structure to provide a second transmission zero.
